(19) United States
(12) Patent Application Publication
(10) Pub. No.: US 2026/0227541 A1
(43) Pub. Date: Aug. 6, 2026

(54) Autonomous Rover for Detection of Precious Metals and Meteorites

(71) Applicant: CRAIG Thomas FLANAGAN, Freehold, NJ (US)

(72) Inventor: CRAIG Thomas FLANAGAN, Freehold, NJ (US)

(73) Assignee: CRAIG FLANAGAN, Freehold, NJ (US)

(21) Appl. No.: 18/813,413

(22) Filed: Aug. 23, 2024

Related U.S. Application Data
(60) Provisional application No. 63/628,909, filed on Aug. 31, 2023.

(51) Int. Cl. G01V 3/15; G01V 3/38; G05D 1/648

(52) U.S. Cl. CPC G01V 3/15; G01V 3/38; G05D 1/648

(57) ABSTRACT

Described herein is a rover-based method and system for finding gold nuggets, meteorites and other minerals detectable by electronic-based means. The rover runs autonomously after being provided with a waypoint mission by the operator. The autonomy of movement includes obstacle detection and avoidance. Target mineral detection is accomplished by means of a trained convolutional neural network which interprets audible and/or electronic signals from an integral metal detector. Missions run by the rover include, but are not limited to, detection of gold nuggets and meteorites.

### CROSS REFERENCE TO RELATED APPLICATIONS

This application claims the benefit of US Application 63/628,909 which is hereby incorporated for reference in its entirety.

### PRIOR ART

The following is a tabulation of some prior art that presently appears relevant.

### US Patents

| Patent Number | Kind Code | Issue Date | Patentee |
|---|---|---|---|
| 10,274,632 | B1 | 2019 Apr. 30 | Olsson |
| 11,315,229 | B2 | 2022 Apr. 26 | Vaidyanathan |
| 10,838,099 | B1 | 2020 Nov. 17 | Wu |
| 10,445,398 | B2 | 2019 Oct. 15 | Muensterer |
| 9,568,635 | B2 | 2017 Feb. 14 | Suhami |
| 9,541,641 | B2 | 2017 Jan. 10 | Stolarczyk |
| 11,965,716 | B2 | 2024 Apr. 23 | Jones |
| 9,651,341 | B2 | 2017 May 16 | Nelson |
| 10,570,736 | B2 | 2020 Feb. 25 | Wang |

US Patent Applications

| Publication Nr. | Kind Code | Publ. Date | Applicant |
|---|---|---|---|
| 20230029746 | A1 | 2023 Feb. 2 | Raufi |
| 20230243980 | A1 | 2023 Aug. 3 | Allen |
| 20060279450 | A1 | 2006 Dec. 14 | Annan |
| 20020140596 | A1 | 2002 Oct. 3 | Stolarczyk |
| 20030034778 | A1 | 2003 Feb. 20 | Nelson |

### Nonpatent Literature References

Madhu H M et al., Metal Detector Robotic Vehicle. International Journal of Research and Analytical Reviews (IJRAR), IJRAR.ORG,
Thuraya Nasser Ibrahim Alrumaih, “The Construction of a Robotic Vehicle Metal Detector as a Tool for Searching Archaeology Sites”, Year-2016, pp. 56-58.

### BACKGROUND OF THE INVENTION

The current state of the art in near surface gold nugget detection consists of metal detecting using the principle of emitting an electromagnetic field through a coil and using said coil to detect reflected electromagnetic fields. The reflected electromagnetic field thus containing potential information about the mineral content of the surface/sub-surface area proximal to the detector coil. Common types of metal detectors include the so-called VLF or very low frequency detectors which have a dual coil arrangement for the delivery of low frequency electromagnetic signals into the ground and for the receiving of these signals after they have been (potentially) modified by the presence of a metallic object in the soil. Variants of this scheme include the so-called multi-frequency metal detectors in which the frequency of the electromagnetic fields can be altered by either the machine or the operator. This ostensibly allows for greater operational utility with respect to target discrimination and identification as compared to the VLF detectors. Finally, a more sophisticated detector type has appeared in recent years and is known as a pulse induction or PI detector. These detectors rely on one coil as opposed to a coil pair to transmit and receive electromagnetic signals. PI detectors emit pulses of very short duration (on the order of milliseconds) and with a frequency of perhaps several hundred pulses per second. The detector then monitors the electromagnetic field of the reflected pulses, which may be indicative of the presence of a conducting metal. All of these detector types produce audible and/or electronic indicators for the presence of metals and the audible and/or electronic indicators often allowing for differentiation of metal type and depth by the experienced operator.

In regions where there are significant quantities of valuable metals at or near the surface, these detectors can be used to collect these metallic specimens. For instance, Western Australia is known to have significant quantities of gold nuggets at or near the surface and dispersed throughout a number of regions. Prospectors are known to locate these valuable nuggets using gold detectors for fun and profit. Indeed, a recent television show called “Aussie Gold Hunters” (produced by Electric Pictures; Perth Western, Australia) has documented the exploits and finds of some of these prospectors in the gold fields of Western Australia.

The process of locating gold nuggets by the use of a detector, which is hand held, and which must be swept over the ground by the operator, involves a sweeping motion of the detector coil typically a lateral or side-to-side motion around the body of the operator thus forming a horseshoe type pattern. The operator then advances forward making repetitive sweeps in an effort to cover the ground in front of him/her and to the right and left hand sides. This motion is continued until a detector sound (and/or electronic signal) indicative of the presence of a conductive metal is heard at which point the operator digs for the identified target to determine if it is a valuable gold nugget.

Although it is possible to make money and even a living finding gold nuggets by using such metal detectors (particularly in Western Australia), prospectors are limited by having to carry around a metal detector and sweep the ground constantly in the tedious and repetitive search for these valuable gold nuggets. Hours of this work per day can fatigue a prospector and so a balance must be struck between fatigue and motivation which might see for instance 6, or 8, or 10 hours per day per prospector of gold detecting being performed. Further, any repetitive and tiring task becomes mentally fatiguing as well over time. Such tasks lend themselves to the use of robotics to free, in this case, the prospector, from the monotonous and tiring task of sweeping the ground for gold nuggets.

As with gold nuggets which have monetary value, meteorites are highly prized and valuable due, in large part, to their rarity and mystique. Small meteorites can be valued in the thousands of (US) dollars. Meteorites are difficult to locate and are commonly found in ancient dry lake beds in which their presence is easier to determine given the background of the hard surface or salt layer in the lake bed. Meteorite hunters spend countless hours searching these type of sites using metal detectors for meteorites but as with gold nugget detecting, it is a labor intensive and tedious endeavor.

### SUMMARY OF THE INVENTION

A system and method for locating valuable minerals including gold and meteorites is disclosed. The system and method solves the problems disclosed above by providing an autonomous or self-navigating and artificial intelligence (AI) based robotic means of locating valuable minerals. The robotic vehicle (or rover) leverages an on-board guidance system and a metal detection means in order to scan large areas without user intervention and subsequently records the location of potential targets for later retrieval by the user.

An advantage of the present invention is that it allows for long duration operation up to and approaching 24 hours of operation per day, in which valuable minerals can be prospected/located. This significantly exceeds the typical capability of a prospector using a hand-held metal detector.

An advantage of the present invention is that is provides a probabilistic AI-based framework for target identification which can be used as a (user controlled) filtering means for selecting the highest probability targets for further investigation.

A still further advantage of the present invention is that it allows for the control of multiple rovers concurrently further increasing by means of scaling the prospecting duration advantage previously noted.

A still further advantage of the present invention is that it ensures by navigational means that areas of interest are fully covered by the metal detector coil. This being ensured by proper design of a waypoint navigation strategy in the invention's ground control software. This eliminates the potential of inadvertently untested areas which cannot be easily tracked by prospectors using a hand-held detector.

A still further advantage of the present invention is that (during the invention's “gold recovery” mission) the rover will walk the user directly to the location of the mineral targets located, thus ensuring efficient use of the prospectors time.

A still further advantage of the present invention is that the user can quickly set up waypoint missions and transfer those missions wirelessly and easily to the rover after which time the rover will conduct the mission, allowing the user to be freed of prospecting activities and allowing the user to accurately cover grounds of interest.

These and other elements of the invention will likely become clear to those of ordinary skill in the art having read the description of the embodiments which follow herein of the invention which is summarized in detail and illustrated in the various drawing figures.

An embodiment of the autonomous or self-navigating rover consists of a rover chassis which carries both electronics and a metal detector. Included in the chassis electronics is a navigational guidance system which itself includes a real time kinematics (RTK) GPS receiver coupled with an external base station for real-time guidance and geospatial locating (target position identification). The rover includes a processor (Pixhawk Cube, CubePilot, Breakwater, Victoria, Australia) for running an autopilot code-base (ArduPilot, ArduPilot.org) which enables waypoint navigation capability. The rover further includes an AI capable processor (Jetson Nano, NVIDIA, Santa Clara, CA) for running a convolutional neural network (CNN) trained to identify the possibility of a valuable mineral based on the sound and/or electronic signal emitted from the integral metal detector. The rover is programmed to back up (reverse) once a potential mineral target is identified during its waypoint mission by the AI means (referenced earlier) and sweep its trailing metal detector side-to-side to obtain a more precise secondary indication of the presence of a valuable mineral using the inferencing of a second trained CNN. The rover contains an on-board touchscreen display which allows the user to track mission progress, locate identified targets, control rover progress during the “gold retrieval” mission, and set CNN inference thresholds for missions. The rover is provided with a waypoint mission by means of an external computer running a ground control software (Mission Planner, https://ardupilot.org/planner) or by means of an integrated remote control, ground station and wireless data transmission system such as the Herelink (CubePilot, Breakwater, Victoria, Australia). Two successive missions are run by the rover, first a “gold prospecting” mission moves the rover through a set of predefined user waypoints to search for potential mineral targets. Second, a “gold recovery” mission moves the rover to each potential target identified in the “gold prospecting” mission and stops the rover at those targets (subject to the user commanding the rover to continue by means of the on-board touchscreen) for potential user recovery of the identified minerals.

Optionally, the RTK GPS ground station may be replaced by an NTRIP caster (network transport of RTCM via the internet) which provides for GPS correction data to the GPS receiver integral to the rover via the internet.

Optionally, the rover may be a four wheeled rover or a six wheeled rover as is depicted in FIG. 1. in which all or most of the wheels are powered independently and the front and back wheels steer while the two sets of (two) side wheels are arranged in a bogey configuration and provide for vehicle steering by a skid steer means.

Optionally, the autopilot system may consist of other commonly available autopilot systems such as Inav (https://github.com/iNavFlight/inav) or F Prime (https://github.com/nasa/fprime).

Optionally, the autopilot hardware may consist of other commonly available hardware such as the Control ZERO H7 (3DR, Chula Vista, CA) Navio2 (EMLID, Budapest Hungary),, or Beaglebone Blue (https://beagleboard.org).

Optionally, the AI processing board may consist of other commonly available processing boards such as the Jetson Orin NX (NVIDIA, Santa Clara, CA) or the NVIDIA Orin Nano (NVIDIA, Santa Clara, CA).

Optionally, the integral trained convolutional neural networks (primary and secondary) may alternately consist of graph neural networks or capsule neural networks or similar alternative AI frameworks.

### TECHNICAL FIELD OF THE INVENTION

The present application relates to the enhancement or augmentation of mineral detection. More specifically, the present disclosure relates to the intelligent and automatic detection of valuable minerals using robotic means.

### BRIEF DESCRIPTION OF DRAWINGS

The invention can better be understood in reference to the following drawings and descriptions. The components in the figures are not necessarily to scale but instead designed to illustrate the principles of the invention.

FIG. 1 depicts the general operational principle of the invention in which satellite (GPS) data is used by a rover to self-navigate to predefined waypoints. The rover itself carries a metal detector to search for valuable minerals and uses extensive on-board electronics to carry out its missions.

FIG. 2 is a Venn diagram illustration of the intersection of operational hardware and techniques employed in the invention.

FIG. 3 depicts a detailed operational description of the invention including sub-system inter dependencies.

FIG. 4 shows the progression of tasks or workflow for the invention during the search for valuable minerals inclusive of the two sequential missions, the “gold prospecting” and “gold retrieval” missions.

FIG. 5 is a flowchart of sequential operations that the invention (rover) performs during operation.

FIG. 6 depicts a typical waypoint mission with interconnected waypoints and inclusive of fenced exclusion zones.

FIG. 7 illustrates the concept of the invention (rover) backing up (reversing) incrementally and sweeping its metal detector coil (also referred to herein as a sweeper) laterally to secondarily detect the presence of an initially detected mineral target.

FIG. 8 is a flow diagram of the steps taken by the AI processing unit integral to the invention to assess the validity of a potential mineral target using the inferencing of two successive trained convolutional neural networks.

FIG. 9 is a flow diagram of the steps needed to train both the primary and secondary convolutional neural networks.

FIG. 10 shows the sequence of events involved in integrating LIDAR and SONAR data into one signal for use by the integral autopilot system.

FIG. 11 depicts a mobile command center capable of concurrently controlling multiple rovers.

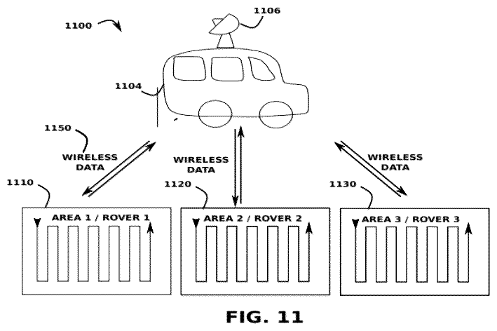

FIG. 12 depicts the concept of phase-based averaging of the sound and/or electronic signals coming from the detector during the sweeping process.

FIG. 13 illustrates the steps required to convert the Ackermann rover control data from the autopilot system to a 6-wheeled rover incorporating direct steer front and back wheels and skid steer side bogey wheel pairs.

### DETAILED DESCRIPTION OF THE DRAWINGS

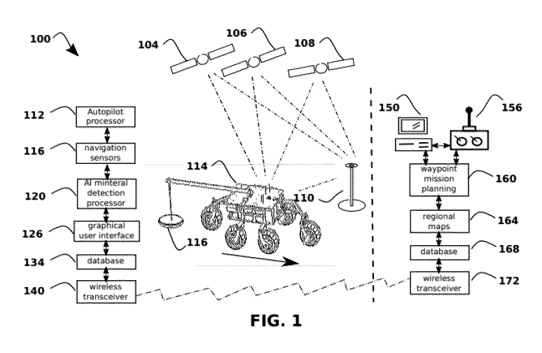

FIG. 1 provides a view of elements of the invention. The embodiment pictured is a 6-wheeled rover 114 however in some embodiments, the rover may have a different number of wheels. The rover includes real time kinematic (RTK) GPS receiver and GPS base station 110 elements for geospatial location by way of receiving data from GPS satellites 104, 106, 108 of one or more of the five existing GPS constellations (GPS (US), QZSS (Japan), Beidou (China), Galileo (EU), Glonass (Russia)). The number of satellite signals being received by the rover and base station is understood to be dynamically variable. Additionally, in another embodiment, the GPS base station may be replaced by an NTRIP caster (network transport of RTCM via the internet) which provides for GPS correction data to the GPS receiver (as is the purpose of the GPS base station) integral to the rover via the internet

The rover element of the invention includes, in the pictured embodiment, what will be herein referred to as a “sweeper” 116 which consists of an integrated metal detector coil and swing arm which is rotated under the command of the rover electronics about the approximate midpoint of the rover ensuring nearly lateral sweeping action at the ground level. Included on the rover element of the invention are elements which allow the rover to carry out its mission of searching for valuable minerals, these elements include an autopilot processor 112 which may comprise a microprocessor as a Pixhawk Cube (CubePilot.org) running autopilot software such as ArduPilot (ArduPilot.org). Other combinations of autopilot microprocessor hardware and autopilot software are available commercially or as open source elements and should be understood to be within the scope of this invention. Additionally, in the pictured embodiment, navigation sensors 116 are integrated into the rover. Such sensors may include GPS sensors, magnetometers, inertial measurement units (IMUs), accelerometers, and other sensors known in the art for facilitating the navigational computations of the autopilot. The rover element of the invention in the pictured embodiment also includes an artificial intelligence (AI) mineral detection processor 120 for determination of the presence of valuable minerals proximal to the metal detector coil during rover operation. Such a processor must be capable of running AI-based inferences in real time and one exemplary processor is the Jetson Nano (NVIDIA, Santa Clara, CA) which has 128 parallel GPU units suited for complex matrix oriented calculations synonymous with AI implementations. Other processors are known in the art and should be considered an obvious extension of the invention. The rover element of the picture embodiment contains a graphical user interface 126 which consists in one embodiment of a touch screen OLED display allowing for the presentation of data and receipt of user data by means of the touch element of the display. The rover element of the invention includes a database 134 of GPS coordinates, navigation obstacles and other elements necessary for navigation of the rover. Finally the rover element of the invention includes a wireless transceiver 140 allowing for communications with the external GPS base station and with user devices such as a PC or RC transmitter or Herelink (CubePilot, Breakwater, Victoria, Australia).

Pictured additionally in FIG. 1 are two means of user interaction with the rover element of the invention. These include an RC receiver or Herelink 156 and a PC or laptop 150. These two elements of the invention provide bi-directional wireless data transmission to/from the rover and can be used independently to operate the rover, or in combination and indeed can communicate with each other wirelessly to share data. Provided on these two platforms (150, 156) is ground control software such as Mission Planner (https://ardupilot.org/planner) or similar such as QGroundControl (QgroundControl.com). Such ground control software provides local regional maps 164 of areas of interest for mineral exploration inclusive of user stored tiles of geographic areas in an integral database 168. Such ground control software allows for easy waypoint mission creation 160 which can be wirelessly transmitted 172 to the rover element of the invention.

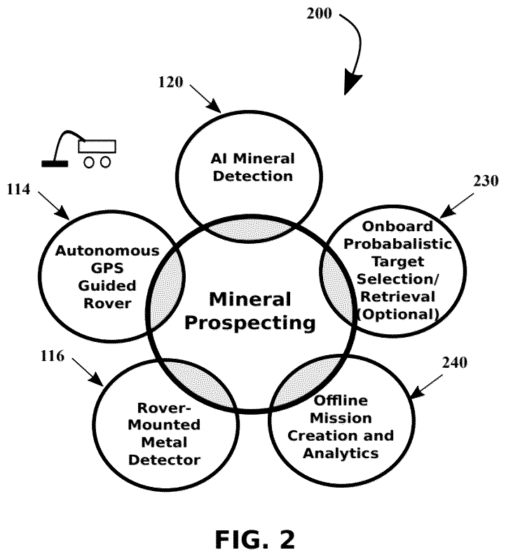

FIG. 2 illustrates a VENN diagram of the intersection of key elements of the invention. This consists of the GPS guided autonomous or self-navigating rover 114 previously described herein. The descriptor autonomous and/or self-navigating is intended to indicate that the rover operates on its own and without required user intervention once provided a waypoint mission and once commanded by the user to begin the waypoint mission. Attached to the rover element of the invention, is a metal detector 116. It is understood that the metal detector may be of any type available commercially and it is further understood that the mounting of the metal detector may be on the rover body proper, or be within the previously described sweeper, or may be tethered to the rover. In any embodiment, the metal detector moves coincident with, or in tandem with the rover element of the invention. On-board the rover is an AI mineral detection processor 120 which determines the presence of minerals using a trained convolutional neural network or similar AI or machine learning technique. Many such techniques involving the training of a mathematical transform to recognize the presence of minerals by way of the recorded audio sounds and/or electronic signals from a metal detector can be envisioned and should be considered to be simple and obvious variants of the invention provided here and further within the scope of this invention. Additionally, one embodiment of the invention includes a user mediated selection of a probabilistic threshold 230 for the primary, secondary or both convolutional neural network inference results. As such, the user may indicate by way of the graphical user interface touchscreen a probability threshold for the metal detector signal to be a valuable mineral. By way of example, the user may set the threshold at 60% probability, and thereafter the rover would only record the GPS locations of targets which exceed a 60% probability of being a particular mineral that it has detected. This probabilistic thresholding can also be used for additional distinguishing elements of the CNN training set such as depth of target, size of target, type of target material and other features which the CNN can distinguish based on its training regimen. It is understood that feature 230 is optional and may not be included in some embodiments. Finally, the invention includes offline processing 240 by way of a user PC, laptop, Herelink, RC Transmitter or other processing based transceiver device. Such a device, running a ground control software such as Mission Planner, will allow for mission creation and mission analytics. By way of example, Mission Planner, which communicates with the rover autopilot using a communications protocol known as MavLink (www.mavlink.io), allows for the tracking and off-line recording of critical sensor system performance and AHRS (altitude and heading reference system) data (note such data can also be tracked on-line by the autopilot processor itself), such data can then be used for post hoc evaluation of rover mission performance.

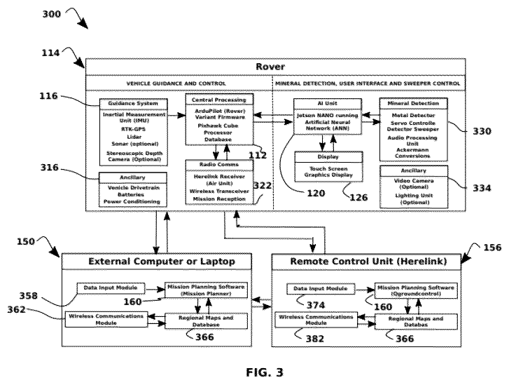

FIG. 3 provides an overview of critical elements of the invention 300 and extends the system details provided in FIG. 1 with additional detail. It should be noted that details provided in FIG. 1 with respect to elements of 150 and 156 are shown in consolidated form while FIG. 3 breaks out these elements with the elements assigned to both 150 and 156 individually. As noted previously herein, the invention consists of a rover element 114 and an external processing and communications device 150, 156. It is understood that only one of the two external communications devices shown in FIG. 3 as 150 and 156 is necessary although both can be used. Therefore some embodiments of the invention will consist of 150 and 156 and some embodiments of the invention will consist of 150 and some embodiments of the invention will consist of 156. The rover element of the invention consists of a number of sub-components or sub-systems. Included in these are the guidance system sensors 116. The guidance system sensors include any number of sensors to facilitate rover autonomous or self-navigating (defined herein) guidance during its mission to include GPS sensors, magnetometers, inertial measurement units (IMUs), accelerometers, SONAR, LIDAR, stereoscopic depth cameras and other sensors known in the art for facilitating the navigational computations of the autopilot. Such sensor data is fed to the autopilot 112 integral to the rover element of the invention and consumed within the autopilot software by a Kalmann filter, a Bayesian network for estimation of vehicle state recursively over time using incoming data from said sensors. Other techniques for vehicle state estimation may be used and should be considered to be within the scope of this invention. Further other non-GPS techniques of vehicle navigation such as odometry, SLAM (simultaneous location and mapping) and others known in the art should be considered obvious extensions of the concepts presented here and within the scope of the invention. In one embodiment of the invention, obstacle detection is achieved by means of a stereoscopic camera mounted on the rover and communicating with the autopilot. In another embodiment of the invention, obstacle detection is achieved by means of a LIDAR (light detecting and ranging) unit mounted on the rover and communicating with the autopilot. Object avoidance is achieved by one or a combination of modern obstacle avoidance algorithms known in the art such as “bendy ruler” and “Dijkstra”. An internal database in the autopilot tracks waypoints and potential obstacles. Ancillary elements 316 of the invention include the vehicle drivetrain, which as noted herein may be of multiple wheel count, the batteries which in one embodiment of the invention are rechargeable lithium polymer batteries. Other battery chemistries may be used in additional embodiments of the invention to include but not limited to lithium ion, lithium iron phosphate and nickel metal hydride. Power conditioning circuitry which produces the (predominantly) DC voltages required to run various sub-systems is also included in one embodiment of the invention. Such output voltages may include, but are not limited to, commonly used input voltage levels for common devices of 3.3 VDC, 5 VDC, 12 VDC and 24 VDC. Such power conditioning circuitry may comprise in at least one embodiment of the invention, DC-DC boost and/or buck power converters as well as linear converters. The rover element of the invention also includes a central processing unit 112 otherwise or alternately equivalently referred to herein as an autopilot. One such example being a Pixhawk Cube (CubePilot, Breakwater, Victoria, Australia). Such autopilots contain a powerful microprocessor and may include additional sensors to aid in navigation. Many navigation oriented sensors not included in the autopilot proper (such as GPS) may be interfaced to the autopilot which will consume the data provided as input to the aforementioned integral Kalmann filter of the autopilot software. The vehicle guidance and control element of the design of FIG. 3 includes wireless communications modules or transceivers 362 and 382 (previously described in FIG. 1 in a consolidated representation as 172) to output and receive data from external devices. One embodiment of the invention includes a Herelink receiver 322 (also known as a Herelink air unit) to transceive data from the external Herelink user handheld unit 156. Such wireless communications devices integral to at least one embodiment of the invention allow for waypoint mission reception from external devices as well as the broadcasting of mission-oriented sensor data to the external devices. The rover element of the invention also includes in at least one embodiment an AI processing unit 120 such as a Jetson Nano (NVIDIA, Santa Clara, CA). This processing unit is employed to run the computationally intensive primary and secondary CNNs described elsewhere herein, as well performing the a number of tasks 330. Tasks performed by the AI processing unit include interfacing with the graphical user interface (display) 126, controlling the sweeper, the movement of which is actuated by a linear servo interfaced to the AI processor, recording/monitoring audio data from the metal detector by way of an audio capture card, and providing for Ackermann vehicle control conversions to other vehicular configurations that the rover may take on, such as the 6-wheeled configuration of FIG. 1. An additional element of the invention which may be included in some embodiments and excluded in others, is a lighting system 334 for the rover to assist during night operation and a video camera 334 which is configured to broadcast video footage from the rover to the ground station running on a PC, laptop, Herelink or RC transmitter. Data communications in one embodiment of the invention includes data transceived by the integral autopilot with an external computer or laptop 150 or a remote control unit such as a Herelink 156 in one embodiment or an RC transmitter in another embodiment. Relative to the external PC or laptop 150, a keyboard 358 is needed for data input (in other embodiments this may be replaced by a mouse). A wireless communications module 362 exists in one embodiment of the invention to consist of a wireless facility integral to the PC or laptop. Mission planning software such as Mission Planner 160 (ardupilot.org/planner) is run on the PC/laptop which facilitates waypoint mission planning and mission visualization 366 which is superimposed as vectors on geographic tiles displayed in the software. In an embodiment employing the remote control unit 156, many remote controls units are commercially available including the Herelink system which allows for the running of ground control software such as Mission Planner or Qgroundcontrol (Qgroundcontrol.com) 160. As noted herein, ground control software will facilitate mission planning and visualization 366. Inclusive in the design of external remote control units, are data input modalities 374 and wireless transceivers or modules 382.

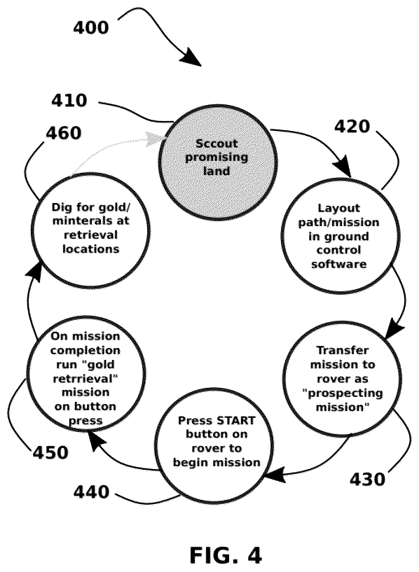

FIG. 4 illustrates the workflow 400 of the invention which starts with the user scouting promising gold locations 410. Next, the mission is planned 420 in the ground control software on one of the external devices previously described herein 150, 156. The mission will consist of a series of geographic (GPS) waypoints that the rover is to follow as best it can during the mission (the rover will temporarily modify its course if an obstacle is sighted). This waypoint mission is then transmitted wirelessly to the rover as a “prospecting mission” 430. A prospecting mission is a mission in which the rover follows a set of waypoints aimed at provided good or even complete coverage of an area by the coil of the detector passing over it. Such a mission is designed to search exhaustively for mineral targets. Once the mission is loaded into the rover's autopilot, the AI processor will recognize the existence of a mission in the memory of the autopilot and will prompt the user via the touch screen graphical user interface to begin the “gold prospecting” mission by pressing a start button 440. At this point in time the user may also choose to select the probabilistic thresholds for the primary and secondary CNNs on the graphical user interface. Once the mission has been started, the rover will run the mission without any required user intervention and return to the starting point at which it began its mission upon completion. All potential mineral targets identified (consistent with any probabilistic targets set) will be recorded as GPS locations in the AI processor. The AI processor will then prompt the user via the touchscreen graphical user interface to begin the next mission known herein as the “gold retrieval” mission 450. Upon selection of a start button for the “gold retrieval” mission, the rover will walk the user to each location at which a potential mineral target was sensed. The rover will stop at each target allowing the user to dig for the target 460. The rover will subsequently provide the user a button to resume the mission (upon completion of the digging for the mineral) which upon pressing, the rover will walk the user to the next target. This process repeats until the rover returns to its home position and again waits for the introduction of a new “gold prospecting” mission to be sent to it.

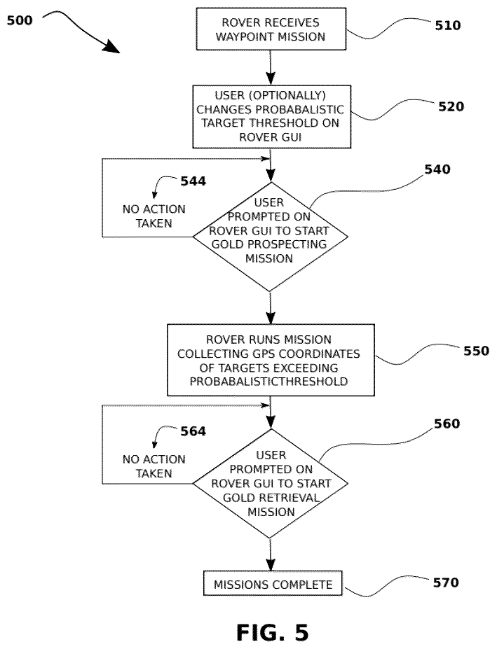

FIG. 5 provides another look at the progression of events associated with running the two sequential missions 500 (the “gold prospecting” and “gold retrieval” missions). The events begin with the rover receiving a waypoint mission 510 which as previously described consists of the user creating and wirelessly transmitting the mission to the rover. The rover will then display on its touchscreen graphical user interface a user option to change probabilistic thresholds of differentiating trained elements of the CNN such as target depth, surety of target existence, type of metal, and other features. The user may set these thresholds or chose to simply ignore them (thus choosing the default thresholds) 520. Next, the user is prompted by a button on the touchscreen graphical user interface to start the mission 540. The user may chose to start the mission or not take any action 544 at which point the rover will wait for the user to take action. The rover next runs its “gold prospecting” mission collecting the GPS locations of targets which exceed its probabilistic thresholds based on the inferencing from the CNN 550. Upon mission completion, the rover will then prompt the user via a button on its touchscreen graphical user interface to begin the second sequenced “gold retrieval” mission 560. Should the user choose not to proceed with this mission 564 the rover will hold in place and wait for user input. It should be noted that the user may choose to enter a new “gold prospecting” mission into the rover at this time. Finally, upon completion of the “gold retrieval” mission, the rover will return to its home location.

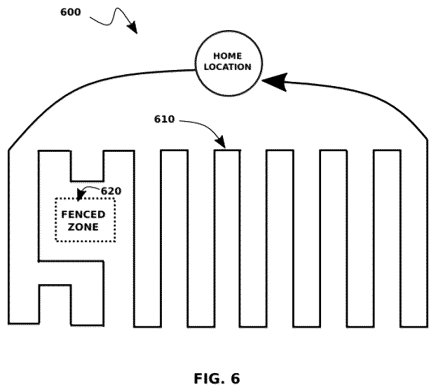

FIG. 6 shows a simplified version of a waypoint mission 600 as created by the user on an external laptop, PC, Herelink or RC transmitter. The waypoint missions may consist of a back-and-forth pattern as shown 610 or may have other shapes such as a spiral pattern. In either case, the lines which indicate rover path may be arranged so as to be close enough together that there is no overlap or a percentage overlap of the previous line. For instance, if the metal detector coil is twelve inches wide, the search pattern may have the lines spaced at eight inches from line to line thus the coil overlaps its previous search path by approximately 33%, thus ensuring that no areas are left unexplored or uncovered by the coil of the detector. This being a significant advantage over detecting for gold by a hand held unit in which the paths of the coil are not tracked and unexplored areas may occur as well as significant and unproductive retesting of areas already covered. The Mission Planner software used in at least one embodiment of the invention offers provisions for exclusion of particular land masses 620 where, for instance, a large ditch or pond may be known to exist. Mission Planner will plan its waypoint mission to exclude this area as is illustrated.

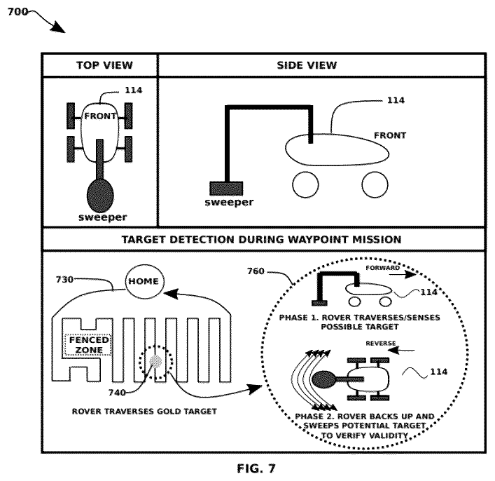

FIG. 7 illustrates the working principle of the sweeper 700. The sweeper holds the coil of the metal detector and the body of the metal detector which contains the electronics, in one embodiment, co-located with the sweeper or, in another embodiment, located on the body of the rover and tethered electronically to the sweeper mounted coil by wire. The sweeper is located to the rear of the rover and its shell is constructed, in at least one embodiment of the invention, of an abrasion resistant non-magnetic material. In one embodiment of the invention, the sweeper is constructed of kevlar, allowing it to be dragged on the ground without significant wear degradation. In one embodiment, the sweeper is surrounded by an electromagnetic damping material or fabric to reduce any electromagnetic interference being produced on the rover and predominantly from the DC motors which are known to produce wide spectrum electromagnetic interference. In another embodiment, this electromagnetic interference is addressed at its source by surrounding each DC motor on the rover with a small Faraday cage or by placing a capacitor and/or varister on the motor to minimize electromagnetic emissions. As the rover progresses on its “gold prospecting” mission 730, the AI processor monitors the sounds and/or electronic signals coming from the metal detector using its primary CNN algorithm. Upon traversing a mineral target 740 which exceeds a predefined probabilistic threshold in the primary CNN algorithm (illustrated as Phase 1) the rover will be commanded to stop (by a command sent from the AI processor to the autopilot) and subsequently commanded to reverse in small increments of several inches 760. At each backup increment, the rover will stop and the sweeper will be commanded (by the AI processor) to sweep back and forth a number of times. The rover will then be commanded to back up again by several inches at which point the sweeper will once more be commanded to sweep back and forth a number of times. This process repeats several times until either a secondary indication of the presence of a target is obtained (and GPS location logged) by exceeding a preset probabilistic threshold on a secondary CNN algorithm or by exhausting the preset number of backup and sweep maneuvers programmed into the AI processor without the preset probabilistic secondary CNN algorithm threshold being exceeded (i.e. no mineral target verified). It is of note that the primary and secondary CNN algorithm structure is an important element of the invention as intermittent and spurious noise from metal detectors is common and may exceed the primary CNN algorithm threshold, thus producing false positives. With the secondary CNN algorithm, a layer of target verification is added to reduce the occurrence of false positives.

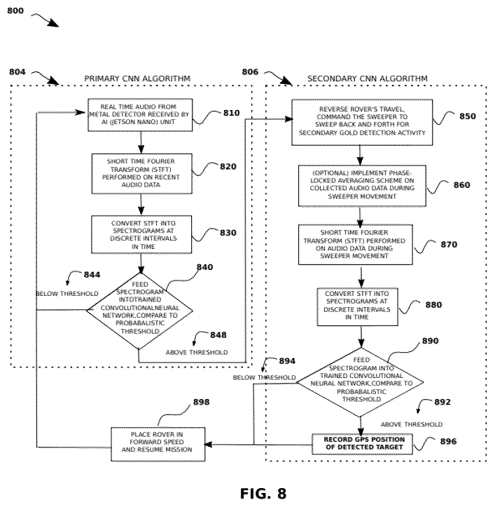

FIG. 8 expands on the concept 800 integral to the invention of a primary 804 and secondary 806 convolutional neural network (CNN) implemented on the AI processor in at least one embodiment of the invention. In this process, real-time audio (sound) data and/or electronic signals originating from the body of the metal detector is collected by the AI processor 810. This is achieved in one embodiment by the use of an audio processing card specific to the Jetson Nano AI processor known as a Waveshare card (waveshrare.com/wiki/Audio_Card_for_Jetson_Nano) which captures and digitizes the audio data. Other methods of audio collection and digitization for use by a processor are known in the art. The audio data is collected continuously during the “prospecting mission” of the rover. Within the AI processor, audio data is placed in one or more arrays representing several seconds of the most recent collected data. This array or arrays are repopulated at fixed intervals in time always ensuring that the array represents the most recent previous several seconds of audio data. The array(s) are then fed into a short time Fourier transform (STFT) 820 to produce a spectral representation of the data which also preserves (unlike a Fourier transform) temporal or time-based information. The STFT data for the most recent several seconds of audio data is then converted into a spectrogram 830 which is a 2D representation of the audio data and places the spectral information on the Y axis and time-based information on the X axis. This spectrogram or 2D representation of this most recent audio data is an effective way of feeding the audio data into a convolutional neural network which is effective at processing/inferencing with 2D graphic representations of data such as pictures or, in this case, 2D mappings of audio data. The spectrogram(s) are then fed into a trained convolutional neural network (CNN) which is a classifier meaning that it will try to match a signal to preexisting models or data that it was trained to recognize. In this invention, the CNN is also used in a probabilistic framework 840 meaning that the probabilities of data matches to trained data is determined. Indeed, software platforms for machine learning and AI such as TensorFlow (www.tensorflow.org) or PyTorch (www.pytorch.org) will provide for a probabilistic assessment of whether the data of interest matches a particular data set from the training data that was used to train it. In this invention, probabilistic and predictive outcome for a CNN are used synonymously and can be assumed to be equivalent as they refer to the certainty level at which a CNN can ensure that the data matches a particular pretrained data set element. In at least one embodiment of the invention, Tensorflow is used via the python (python.org) programming language to both run the CNN and to obtain the probabilistic outcome of this CNN classifier using the “model. predict” method integral to Tensorflow. CNN outputs are known as inferences and in this invention, an inference rate of many inferences per second is necessary to ensure that the audio data provided is processed fast enough to provide an inference specific to every few inches of rover travel thus ensuring that when a target is identified the rover can calculate with spatial specificity how far to backup to to assess the target using the secondary CNN. Indeed the Jetson Nano can provide this rapidity of inference output. As the rover progresses during the “gold prospecting” mission, it is thus processing the audio data continuously and if a particular CNN inference does not meet a predefined probabilistic threshold 844, the rover will continue to move forward and no action will be taken by the AI processor. However, if a CNN inference does meet a predefined probabilistic threshold, 848 then the rover will be commanded to stop and subsequently commanded to reverse for short distances of several inches at a time. This is achieved by the AI processor sending a speed command to the autopilot using the Mavlink communications protocol. After each backup episode, and when the rover is at a stop, the sweeper will be commanded by the AI processor to move back and forth (laterally) 850 in order that audio data can be obtained for a secondary CNN assessment of the possible mineral target. This data will be assessed at predefined intervals as was the case for the primary CNN assessment to determine if a predefined probabilistic threshold for the secondary CNN has been exceeded at any point in time. In one embodiment of the invention, a phase specific averaging scheme is applied to this sweeper data in which the audio from multiple sweeps are averaged together with sound and/or electronic signal specific to a particular sweeper angle being added together and divided by the number of sweeps taken to obtain a phase specific average for audio relative to sweeper movement 860. This sweeper phase specific audio averaging will reduce the effect of random or phase insensitive noise in the signal thus improving the signal-to-noise ratio of the overall signal. The phase specific averaging result is then fed into the secondary CNN for inferencing and assessment relative to the set probabilistic thresholds. In one embodiment of the invention this phase specific averaging scheme is not used. Sweeper audio data is subsequently processed as it were in the case of the primary CNN in which a STFT 870 is performed, spectrograms created 880 and fed into the secondary CNN and the probabilistic results assessed in comparison to the predefined threshold. If the threshold is met 892 during this process, the backing up of the rover and the sweeping of the sweeper will cease and the AI processor will query the autopilot to determine the current GPS location (using the Mavlink communications protocol) which it will save in non-volatile memory in the form of a waypoint entry for a “gold retrieval” mission (which itself is a series of waypoints for potential mineral targets as obtained by the rover during the “gold prospecting” mission. Should all of the preprogrammed back up maneuvers and sweeping fail to find a target which exceeds threshold 894, the AI processor will command the rover to resume its mission by placing it in forward speed 898 (by sending a command to the autopilot via the Mavlink communications protocol) and subsequently resuming the process of primary CNN target search and identification.

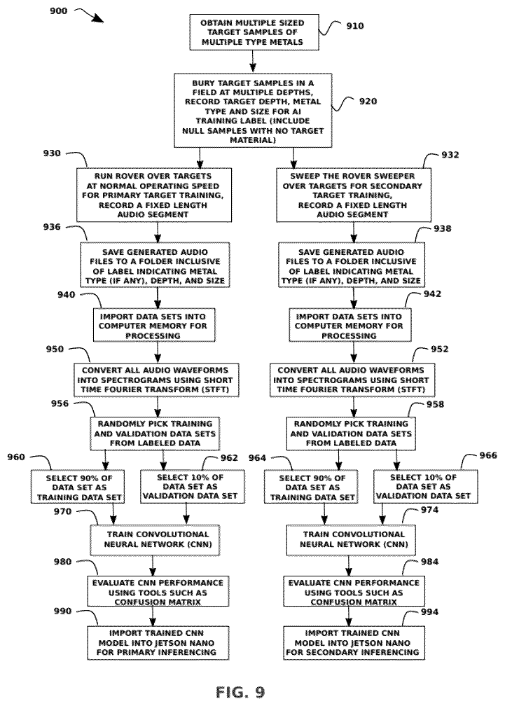

FIG. 9 illustrates the steps taken to train both the primary and secondary convolutional neural networks (CNN) 900 which run on the AI processor. The CNNs are responsible for taking sounds and/or electronic signals emanating from the integral metal detector and determining if the sounds and/or electronic signals indicate the presence of a valuable mineral such as gold. The steps consist of starting the process with exemplary targets 910 of varied material and varied size including null targets which do not activate a response from the metal detector (such as plastics). These targets will be cataloged (also known as labeling) depending on their features for later use during the training process 920. Targets are then buried at varied depth 920 and this too is cataloged. Next, the AI unit is prepped to collect short duration audio clips and two avenues of training are pursued for the primary and secondary CNNs. For the training of the primary CNN, the rover is run over the target at a fixed speed equivalent to the cruising speed which the rover will employ during the “gold prospecting” mission 930. As the rover passes the buried target a short duration audio clip will be saved and this clip will be labeled with the salient features of the target such as metal type, size and depth 936. A similar audio collection exercise occurs for the training of the secondary CNN 932. Specifically, the sweeper is swept over the target with the rover in a stopped position as would occur during the “gold prospecting mission”. The resulting audio clip is saved and labeled with the salient features of the target such as metal type, size and depth 938. Training for the primary and secondary CNNs now proceed with equivalent steps being followed. The collected data sets for the training of both the primary and secondary CNNs are then imported into the memory of a computer 940. 942 which will perform the training. Using the programming language PYTHON (Python.org) and with a machine learning library such as Tensorflow (Tensorflow.org) loaded, all of the audio clips are then converted into spectrograms using a short time Fourier transform (STFT) 950, 952. The labeled data sets are now randomly selected 956, 958 into training (90% of data) and validation (10% of data) sets 960, 962, 964, 966. It should be noted that the relative weighting of these data sets may change and should not be considered fixed). Next the primary and secondary CNNs are trained 970, 974 using the training data set in the Tensorflow (or similar) environment. Finally, the trained CNNs are evaluated for performance using the validation data sets 980, 984 and using tools available (within Tensorflow) for model performance such as a confusion matrix 980, 984. The completed CNN models are then imported into the AI processor for implementation (inferencing) during actual use of the rover 990, 994.

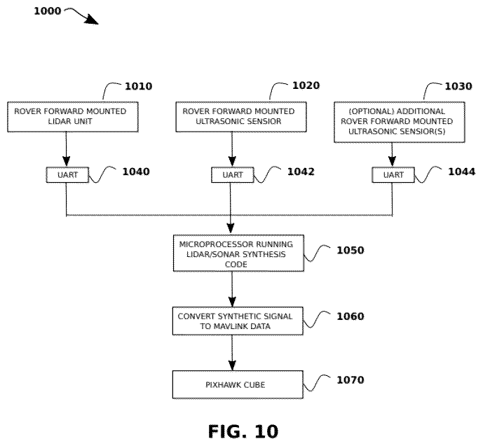

FIG. 10 provides a guidance data integration method 1000 for one embodiment of the invention. The method consists of receiving data from at least one LIDAR 1010 (laser detecting and ranging) unit and at least one sonar 1020 (ultrasonic sensor) unit and potentially other sensors 1030. The data is fed into a receiving processor through UARTS (universal asynchronous receiver-transmitter) 1040, 1042, 1044. The microprocessor, running data synthesis code will take the data and integrate it into a single signal. Specifically, LIDAR data may be effective in determining the location of larger targets at distance while sonar may be more effective at determining the location of smaller targets at shorter distances and thus the two technologies may complement each other. A single data stream will be created 1050 from the two or more incoming sensor data streams with emphasis on identification of targets. Targets missed by one sensor and recognized by another sensor will be reflected in the final data stream. The data stream consists of a time based sequence of scan distances (to targets) based on a 5 degree increment radial sweep, this being the format that the autopilot software (Ardupilot) expects. This data is presented to the autopilot (from the microprocessor collecting the data) in the form of Mavlink messages 1050 which is the communications protocol used for communicating with the autopilot running the Ardupilot codebase. Finally, the guidance data is received by the autopilot 1070 (Pixhawk Cube).

The invention is readily scale-able. Specifically, in one embodiment of the invention, a mobile command center 1100 may be employed on at least one embodiment of the invention. The command center will consist of a command vehicle 1104 with a satellite link 1106 for tasks such as NTRIP caster access and Mission Planner geographic tile downloading. One embodiment of the invention does not require the satellite link. The command center communicates with one or more rovers bidirectionally using wireless means integral to the invention 1150. The rover(s), armed with a (received) “gold prospecting” waypoint mission, will then implement the mission(s) 1110, 1120, 1130 and return to base upon completion. The ability to scale up with the deployment of multiple rovers concurrently is a distinct advantage of this invention as it provides a multiplier effect in which one prospector may do the job of 5, 10 or more prospectors.

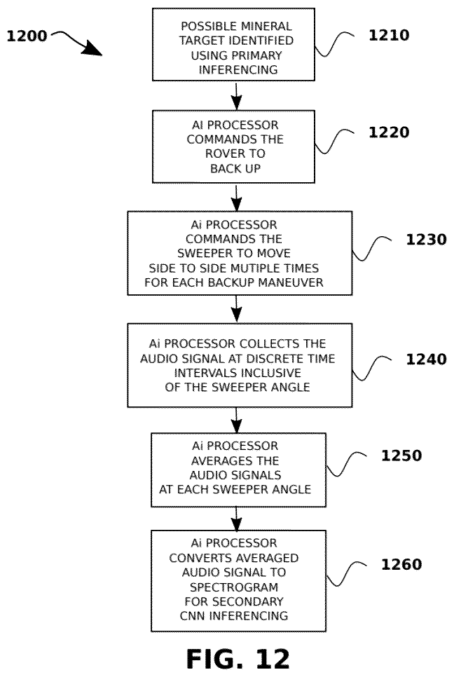

FIG. 12 illustrates a phase dependent audio averaging strategy 1200 employed in at least one embodiment of this invention. In this method, a target is first identified during the “gold prospecting” mission using the inferencing of the primary CNN 1210 running on the AI processor. The rover is then commanded to back up and stop 1220 by the AI processor. The sweeper (which houses the metal detector coil) is then commanded to move back-and-forth laterally 1230. Technically or more accurately, the movement is a radial (circular) sweep with the circular origin at the base of the sweeper however, in practice, and because the sweeper movement subsumes only a small angular displacement, the term lateral is used herein. Next, the audio data collected by the AI processor 1240 is broken into segments representative of portion of the arc traversed by the sweeper. For instance, audio data representing the sweeper position from 12.1 to 12.2 degrees (from center) will be taken and if there are more than one audio data points, the audio data will be averaged for that angular interval to include sound pressure level (SPL) or electronic signal amplitude, and frequency based formants (which represent concentrations of acoustic energy around a particular frequency). Other spectral measures of sound and/or electronic signal may also be used and should be considered to be within the scope of this invention. With the sound and/or electronic signal characteristics now available and representing particular angular displacements of the sweeper, multiple sweeps will be implemented and the sound and/or electronic signal characteristics for those sweeps averaged together 1250 for particular, or specific to, angular displacement intervals. For instance, the audio characteristics for the sweeper position from 12.1 to 12.2 degrees will then be averaged for each sweep. Five sweeps would allow for the averaging of at least five sets of audio characteristics at a particular angular sweeper range (for instance 12.1 to 12.2 degrees). The averaging may occur in one of two ways, the averaging may only occur for sweeper sweeps in a particular direction (i.e. left to right relative to the rover) or the averaging may occur bidirectionally for instance the averaging would occur for sweeper movement from 12.1 to 12.2 degrees left to right as well as for sweeper movement from 12.2 to 12.1 degrees right to left, these data points all being averaged together regardless of sweeper direction. The benefit of such a phase dependent averaging scheme is known in the art for other applications and consists of the degradation of noise sources with spectral characteristics uncorrelated to the signal. The result of such averaging is a gradual improvement or increase in the signal-to-noise ratio as the number of averaged data points increases. Finally, with the averaged phase interval dependent data available at the cessation of the commanded sweeping process, the AI processor takes the data and produces a spectrogram using an STFT. This spectrogram is then fed into the pre-trained secondary CNN for inferencing 1260 and the results compared to the preset probabilistic threshold to determine if the location indicates the presence of a gold nugget or other valuable mineral.

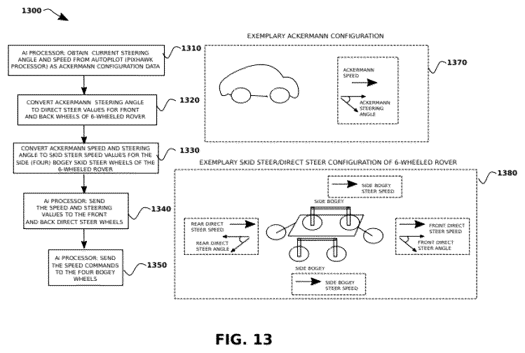

FIG. 13 illustrates the conversion of Ackermann steering to skid steer and direct steer 1300 as employed in at least one embodiment of the invention where the rover is a 6-wheeled/motored rover. As a point of reference, any vehicular command signals originating from the autopilot running Ardupilot will be in one of two formats, a PWM signal representing a so-called Ackermann configuration 1370 in which the autopilot output consists of a PWM encoded (front wheel) steering angle and a PWM encoded vehicular speed. The second format consists of PWM encoded left-hand and right-hand speeds for a so-called skid steer (often employed by battle tanks) arrangement. The 6-wheeled rover 1380 of one embodiment of this invention uses a so-called “direct steer” arrangement for the front and back wheel (meaning the front and back wheels are supplied both with speed and steering angle) and a skid steer arrangement for the four side wheels which are arranged in a 2×2 bogey configuration. In order to properly control the 6-wheeled rover arrangement, the invention converts (in the AI processor) Ackermann signals to appropriate signals for the 6-wheeled rover. To achieve this, AI processor collects Ackermann signals from the (Pixhawk Cube) autopilot (running the Ardupilot codebase) 1310 and converts the Ackermann steering angle to the equivalent direct steer steering angle for the rover 1320. Next, the AI processor converts the Ackermann PWM encoded steering angle and the PWM encoded Ackermann speed signal to skid steer speeds for the two side bogeys 1330. A right-hand and left-hand speed will result. Finally, the Ackermann PWM encoded steering angle and speed signals are converted to PWM encoded speed signals for the front and back direct steer wheels of the 6-wheeled rover configuration. The PWM encoded speed and steering angle signals are sent from the AI processor to the direct steer front and back wheels of the 6-wheeled rover 1340 and the PWM encoded left-hand and PWM encoded right-hand speed signals are sent to the two bogeys (four wheels, each bogey wheel is sent the same speed signal as its same-sided counterpart) 1350. The invention may use motor drivers and motor configurations which take advantage of speed feedback signals coming from encoders or motor speed sensors in a closed loop control configuration, or the invention may use motor drivers and motor configurations which have no encoder or motor speed feedback (in an open loop configuration) and instead use a bank of current sensors configured with one sensor per wheel allowing the AI processor to monitor the relative contribution of various motors based on individual current consumption, thus, allowing the processor to modify or halt rover operation if one motor consumes an unusual amount of current. This to ensure motor loads are roughly balanced and all motors are contributing in like manner to propulsion of the rover.

1. A rover for use in the detection and location of gold or other valuable minerals, comprising:
a vehicle;
a metal detecting apparatus;
a means of self-navigation.

2. The rover of claim 1, wherein the assessment of the presence of a valuable mineral species is performed by an integral artificial intelligence (AI) processor running AI code to interpret the electronic or audible sounds from an integral metal detector to provide a probabilistic assessment of the presence of the mineral species.

3. The rover of claim 1, wherein the assessment of the presence of a valuable mineral is performed using a two tiered process in which; first, a possible signal of the presence of a mineral is obtained while the rover is in forward motion, and second and upon receipt of the signal, the rover performs a confirmatory test of the presence of the mineral target.

4. The rover of claim 1, wherein two missions are preprogrammed into the rover, the first mission consisting of a prospecting mission to locate and record the GPS location of mineral targets, and a second mission to walk or direct the operator to the location of the targets.

5. The rover of claim 1, wherein a probabilistic threshold for the AI classification process is available for user setting.

6. The rover of claim 1, wherein multiple rovers may be deployed concurrently from a remote base station.

7. The rover of claim 1, wherein the navigational input from multiple sensors may be integrated in computer code into a single navigational signal.

8. The rover of claim 1, wherein Ackermann-type steering and speed control signals from the autopilot are converted by integral computer code into the steering and speed control requirements of the particular rover configuration employed.

9. The rover of claim 1, wherein the detection of valuable minerals is mediated by an AI algorithm consisting of a convolutional neural network (CNN) trained to assess, categorize and determine the probability of both the characteristics and existence of potential targets.

10. The rover of claim 1, wherein a phase-based averaging scheme based on sweeper movement is implemented for improved signal-to-noise ratio of the original signal.

11. A means of determining the presence of valuable minerals consisting of:
an artificial intelligence (AI) based algorithm to assess electronic and/or audible output
from a metal detector;
a self-navigating rover to carry said metal detector and said AI-based processing algorithm.

12. The means of claim 11, further comprising a two tiered process in which; first, a possible signal of the presence of a mineral target is obtained while the rover is in forward motion, and second and upon receipt of the signal, the rover performs a confirmatory test of the presence of the mineral target.

13. The means of claim 11, further comprising two missions preprogrammed into the said rover, the first mission consisting of a mission to locate and record the GPS location of mineral targets, and a second mission to walk or direct the operator to the location of said mineral targets.

14. The means of claim 11, further comprising a probabilistic threshold for the AI classification process available for user setting.

15. The means of claim 11, further comprising a means of deploying multiple rovers concurrently from a remote base station.

16. The means of claim 11, wherein the navigational input from multiple sensors may be integrated in computer code into a single navigational signal.

17. The means of claim 11, further comprising the detection of valuable minerals as mediated by an AI algorithm consisting of a convolutional neural network (CNN) trained to assess, categorize and determine the probability of both the characteristics and existence of potential targets.

18. An algorithmic method for the determination of the presence of a valuable mineral consisting of:
an AI-based platform to assess electronic and/or audible output of a metal detector;
a two or more staged/tiered target evaluation process;
one or more user defined probabilistic thresholds within said algorithmic method.

19. The method of claim 18, further comprising the detection of valuable minerals as mediated by an AI algorithm consisting of a convolutional neural network (CNN) trained to assess, categorize and determine the probability of both the characteristics and existence of potential targets.

20. The method of claim 18, further comprising a two or more tiered target evaluation method for the assessment of valuable mineral species in which, first, a possible signal of the presence of a mineral is obtained using a probabilistic threshold of an AI inferencing calculation, and second and upon receipt of said first confirmatory signal, a secondary or tiered evaluation of the presence of the mineral target is performed using a probabilistic threshold of an AI inferencing calculation.
